(19) United States
(12) Patent Application Publication
(10) Pub. No.: US 2013/0261255 A1
(43) Pub. Date: Oct. 3, 2013

(54) COMPOSITION INCLUDING A MIXTURE OF A THERMOPLASTIC CONDENSATION POLYMER AND A SUPRAMOLECULAR POLYMER, AND MANUFACTURING METHOD

(71) Applicants: Yves Deyrail, Evreux (FR); Anthony Dufrenne, Theilleme (FR); Samuel Devisme, Rouen (FR); Nicolas Dufaure, Bernay (FR); Jean-Luc Couturier, Lyon (FR); Bruno Van Hemelryck, Chaponost (FR); Manuel Hidalgo, Brignais (FR)

(72) Inventors: Yves Deyrail, Evreux (FR); Anthony Dufrenne, Theilleme (FR); Samuel Devisme, Rouen (FR); Nicolas Dufaure, Bernay (FR); Jean-Luc Couturier, Lyon (FR); Bruno Van Hemelryck, Chaponost (FR); Manuel Hidalgo, Brignais (FR)

(73) Assignee: Arkema France, Colombes cedex (FR)

(21) Appl. No.: 13/880,249

(22) PCT Filed: Oct. 18, 2011
(86) PCT No.: PCT/FR2011/052426

§ 371 Date: Jun. 18, 2013

(30) Foreign Application Priority Data
Oct. 21, 2010 (FR) 1058619

(51) Int. Cl. C08G 71/02

(52) U.S. Cl. CPC C08G 71/02
USPC 524/606; 525/420.5

(57) ABSTRACT

A subject matter of the present invention is a composition comprising:
(i) from 0.1 to 49 parts by weight of at least one thermoplastic condensation polymer; and
(ii) from 51 to 99.9 parts by weight of at least one supramolecular polymer capable of being obtained by the reaction of at least one at least trifunctional compound
(A) carrying first and second functional groups with:
   at least one compound (B) carrying, on the one hand, at least one reactive group capable of reacting with the first functional groups of (A) and, on the other hand, at least one associative group; and
   at least one at least bifunctional compound (C), the functional groups of which are capable of reacting with the second functional groups of the compound (A) in order to form ester, thioester or amide bridges.

### CROSS REFERENCE TO RELATED APPLICATIONS

This application is the U.S. National Phase application of PCT International Application No. PCT/FR2011/052426, filed Oct. 18, 2011, and claims priority to French Patent Application No. 1058619, filed Oct. 21, 2010, the disclosures of which are incorporated by reference in their entirety for all purposes.

### FIELD OF THE INVENTION

The present invention relates to compositions based on thermoplastic polycondensation polymers and on supramolecular polymers, to their process of manufacture and to their use in numerous industrial fields where recourse is had to injection molding.

### BACKGROUND OF THE INVENTION

Injection molding is a technique for the mass production of parts on a large or very large scale.

Injection-molded components are encountered in a great many fields, such as the motor vehicle industry, the electrical goods industry, computer hardware or furniture. In these industrial fields, the dimensions of the molds can vary from a few millimeters to several meters, for motor vehicle bodywork components or garden tables, for example.

Molds, installed on a machine, are generally composed of two shells which are pressed tightly against one another during the molding and then separated in order to make possible the ejection of the molded part. In addition to these shells, the mold can comprise one or more cores intended to form the hollow portions of the part and punches which make it possible to keep openings in its walls. It frequently happens that inserts are placed in the mold, which inserts will subsequently be reencountered included in the part: they are generally threaded components which locally compensate for the insufficient strength of the material making up the body of the part.

In contrast to other processes where the mold is lost, injection molding makes it possible to reuse the molds, which is highly advantageous. Injection molding also makes it possible to obtain very exact and well finished parts which very often do not require any subsequent machining. Injection molding can thus be employed in particular for the manufacture of parts constituting visible portions of household appliances, television sets and motor vehicle dashboards, for example.

The materials employed in injection molding processes must exhibit a low degree of shrinkage. This property is particularly important when materials are injected into molds exhibiting cores. This is because the parts exhibiting a high shrinkage contract during the cooling and sometimes very tightly grip the cores around which they have been poured, which makes it difficult to extract the part.

“Supramolecular” polymers are materials comprising compounds held together by noncovalent bonds, such as hydrogen, ionic and/or hydrophobic bonds. One advantage of these materials is that these physical bonds are reversible, in particular under the influence of the temperature or by the action of a selective solvent.

Some of them additionally have elastomeric properties. In contrast to conventional elastomers, these materials have the advantage of being able to fluidify above a certain temperature, which facilitates the processing thereof, in particular the satisfactory filling of the molds, and also the recycling thereof.

Some of these supramolecular polymers are, furthermore, composed of molecules bonded in networks exclusively by reversible physical bonds. Despite the relatively modest physical bonding forces of the molecules of such a supramolecular network, these materials are, like classic or conventional elastomers, capable of exhibiting a dimensional stability over very long times and of recovering their initial form after large deformations. They can be used to manufacture, for example, leaktight seals, thermal or acoustic insulators, tires, cables, sheaths, footwear soles, packagings, patches (cosmetic or dermopharmaceutical), dressings, elastic clamp collars, vacuum pipes, or pipes and flexible tubing for the transportation of fluids.

Supramolecular materials have already been described by Arkema France. More particularly, Arkema France has already described supramolecular materials which behave as elastomers.

A self-healing elastomeric supramolecular material is furthermore disclosed in the document WO 2006/087475. It comprises molecules including at least three associative functional groups, such as imidazolidone groups, which are capable of forming several physical bonds and which can be obtained by reacting urea with the product of the reaction of a polyamine with triacids. The materials obtained according to the teachings of the documents WO 03/059964 and WO 2006/087475 include triacids connected covalently, via amide functional groups, to intermediate junctions and/or to endings, which are composed of the product of the reaction of the polyamine with urea and which thus comprise numerous associative groups, that is to say including N—H and C═O functional groups capable of combining with one another via hydrogen bonds. Specifically, the publication by P. Cordier, L. Leibler, F. Tournilhac and C. Soulie-Ziakovic in Nature, 451, 977 (2008), mentions that a polymer synthesized according to the procedure described in the document WO 2006/087475 comprises amidoethyl-imidazolidone endings and di(amidoethyl)urea and diamidotetraethyl triurea junctions. It is understood that, due to the process of synthesis of these materials, the chemical natures of the abovementioned junctions and endings are interdependent, in the sense that it is not possible to vary the nature of the amidoethyl-imidazolidone ending without affecting that of the two junctions.

The document entitled “Versatile One-Pot Synthesis of Supramolecular Plastics, and Self-Healing Rubbers” by Damien Montarnal, François Tournilhac, Manuel Hidalgo, Jean-Luc Couturier and Ludwik Leibler, which appeared in The Journal of the American Chemical Society, 131 (23), 7966; 17 Jun. 2009, describes an alternative process for the production of supramolecular polymers, including those having elastomeric properties of the type of those of the publication by P. Cordier et al. This method makes it possible, inter alia, to destroy the interdependence of the chemical natures between the junctions and the endings of the supramolecular network. It thus becomes possible to control the chemical nature of the endings independently of that of the junctions.

These novel self-healing polymers have huge advantages, such as those of being easy to process, of resulting predominantly from renewable starting materials and of being self repairable.

However, it is difficult to employ supramolecular polymers in industrial processes involving injection. In particular, the supramolecular polymers can be transported in screws of injection molding machines and then poured into a mold but, once removed from the mold, they exhibit a high shrinkage, that is to say a decrease in the dimensions of the part, which can occur immediately after, several hours after or indeed even several days after the injection. In quantitative terms, the shrinkage can be characterized from at least one of the dimensions of the part, such as its length. It is thus said, of a part, that it has undergone a shrinkage of X % with respect to the initial length of said part, measured at the time of the injection into the mold, when its length has decreased by X % with respect to the initial length of said part, measured at the time of the injection into the mold.

As injection is a form of transformation much used industrially for numerous applications, there exists a need for novel compositions which exhibit the advantages of the supramolecular polymers described above while being able to be injected.

### SUMMARY OF THE INVENTION

The inventors have now found a way of improving the properties of these novel supramolecular polymers by developing a composition comprising these polymers in combination with specific thermoplastic condensation polymers, among which may be mentioned polyamides. Such a composition can comprise fillers, plasticizers and other additives.

More specifically, a subject matter of the present invention is a composition comprising:

(i) from 0.1 to 49 parts by weight of at least one thermoplastic condensation polymer; and
(ii) from 51 to 99.9 parts by weight of at least one supramolecular polymer capable of being obtained by the reaction of at least one at least trifunctional compound (A) carrying first and second functional groups with:
at least one compound (B) carrying, on the one hand, at least one reactive group capable of reacting with the first functional groups of (A) and, on the other hand, at least one associative group; and
at least one at least bifunctional compound (C), the functional groups of which are capable of reacting with the second functional groups of the compound (A) in order to form ester, thioester or amide bridges.

### DETAILED DESCRIPTION OF THE INVENTION

The inventors have shown that the compositions which are subject matter of the invention, comprising a thermoplastic condensation polymer and a supramolecular polymer, exhibit excellent compromises in properties. In particular, the compositions which are subject matters of the invention make it possible to notably improve the ability of the supramolecular polymers to be employed in industrial processes comprising a stage of injection into a mold while remedying their main defect already mentioned above, namely their high shrinkage.

Furthermore, the self-repair properties of the self-healing supramolecular polymers can be retained in these compositions.

Thus, compositions in accordance with the invention exhibit both self-repair properties but also a significantly reduced degree of shrinkage in comparison with that of the supramolecular polymers used alone.

The inventors have shown, in example 4, that these compositions exhibit a degree of shrinkage of 20% or less while retaining the properties of the supramolecular polymers, such as the self healing, whereas compositions not comprising a thermoplastic condensation polymer having polyamide functional groups exhibit a shrinkage of greater than approximately 25%.

Surprisingly, the inventors have also shown that only thermoplastic condensation polymers make it possible to maintain self-repair properties while exhibiting a significantly reduced degree of shrinkage. Thus, some thermoplastic polymers, not in accordance with the invention, do not make it possible to obtain an acceptable degree of shrinkage (SBS); yet others have a highly negative effect for the self-healing capability (see in particular, in example 4, the compositions comprising the products Lotryl 24MA07 and Evatane 3345 PV).

By way of preamble, it should be noted that the expression “between” has to be interpreted, in the present description, as including the limits mentioned.

The Condensation Polymers

The term “condensation polymer” is understood to mean, within the meaning of the present invention, a thermoplastic polymer or copolymer obtained by a stepwise polymerization reaction, often known as condensation polymerization. Stepwise polymerization or condensation polymerization is characterized by a mechanism of reaction which results in the gradual, relatively slow, growth in the molecular weight of the chains as a function of the degree of conversion of the monomers; the achievement of high molecular weights is possible only at high conversions. Stepwise polymerization or condensation polymerization is a polymerization involving reactions between functional groups of the molecules of monomers or oligomers. Furthermore, although this is not always the case, it is not uncommon, in stepwise polymerization (or condensation polymerization), for there to be elimination of a byproduct (small molecule), such as water, ammonia, and the like, at each reaction stage. In contrast to stepwise polymerization or condensation polymerization, addition polymerization or chain polymerization very quickly generates, that is to say at low conversions of monomers, polymer chains of high molecular weight. In addition or chain polymerization, the monomers do not react with one another; there is instead a tendency to rapidly add to active centers (molecules of initiator or of growing polymer, carriers of the propagation unit, in the majority of cases an ion or a free radical).

By way of example, the condensation polymer is a polymer comprising a polyamide, polyester, polyether, polyetherester, polyurethane or polyurea block.

Advantageously, the condensation polymer according to the invention comprises at least one polyester block. Advantageously, said polyester comprises a copolymer.

Advantageously, said condensation polymer according to the invention comprising at least one polyester block is obtained from at least one of the following monomer molecules: ethylene glycol, 1,3-propanediol, 1,4-butanediol, 1,10-decanediol, dimerized fatty acid reduced in order to obtain the corresponding diol, 2,5-furandicarboxylic acid, succinic acid, azelaic acid, sebacic acid, dodecanedioic acid, myristic acid, tetradecanedioic acid, hexadecanedioic acid, octadecanedioic acid and/or dimerized fatty acids.

Advantageously, said condensation polymer according to the invention is a polyetherester.

Advantageously, the condensation polymer comprises at least one polyurethane block. Advantageously, said polyurethane comprises a copolymer. Advantageously, said condensation polymer comprising at least one polyurethane block is manufactured from at least one polyol, for example chosen from the following polyols: polyols resulting from starch; erythritol; sorbitol; maltitol; mannitol; polyols deriving from sugars, sucrose; isomalt; xylitol; polyols resulting from corn, soya, cotton, rape, sunflower or peanut; glycerol; propylene glycol; ethylene glycol; biodiesel production reaction coproducts; polyethylene glycol (PEG), poly(1,2-propylene glycol) (PPG), poly(1,3-propylene glycol) (PO3G), polytetramethylene glycol (PTMG).

Advantageously, said condensation polymer comprising at least one polyurethane block is a polyetherurethane.

Advantageously, said condensation polymer comprising at least one polyether block additionally comprises polyethers, such as PTMG, PEG, PPG, PO3G and poly(3-methyltetrahydrofuran).

Advantageously, said condensation polymer is a polymer comprising polyamide sequences. The polyamide sequences can be present on the main chain of the condensation polymer or, if they have them, on the side chain or chains. In the continuation of the description, the polyamide sequences are also called polyamide block or unit. In particular, the condensation polymer can be chosen from homopolyamides and copolyamides.

Three types of polyamide units can constitute or form part of the condensation polymer employed in the invention.

According to a first type, the polyamide units originate from the condensation of at least one dicarboxylic acid or anhydride (aliphatic, cycloaliphatic or aromatic), in particular those having from 4 to 36 carbon atoms, preferably those having from 6 to 18 carbon atoms, and of at least one diamine (aliphatic, cycloaliphatic or aromatic) chosen in particular from those having from 2 to 20 carbon atoms, preferably those having from 6 to 15 carbon atoms.

Mention may be made, as examples of aliphatic diacids, of butanedioic acid, adipic acid, suberic acid, azelaic acid, sebacic acid, dodecanedicarboxylic acid, myristic acid, tetradecanedicarboxylic acid, hexadecanedicarboxylic acid, octadecanedicarboxylic acid and dimerized fatty acids.

Mention may be made, as examples of cycloaliphatic diacids, of 1,4-cyclohexanedicarboxylic acid.

Mention may be made, as examples of aromatic diacids, of terephthalic acid (T) and isophthalic acid (I).

Mention may also be made, as examples of diacids, as a function of the number x of carbons of the molecule (Cₓ) of:
C₄: succinic acid from glucose, for example;
C₆: adipic acid from glucose, for example;
C₇: heptanedioic acid from castor oil;
C₉: azelaic acid from oleic acid (ozonolysis), for example;
C₁₀: sebacic acid from castor oil, for example;
C₁₁: undecanedioic acid from castor oil;
C₁₂: dodecanedioic acid from biofermentation of dodecanoic acid=lauric acid (rich oil: palm kernel and coconut oil), for example;
C₁₃: brassylic acid from erucic acid (ozonolysis), which is found in rape, for example;
C₁₄: tetradecanedioic acid by biofermentation of myristic acid (rich oil: palm kernel and coconut oil), for example;
C₁₆: hexadecanedioic acid by biofermentation of palmitic acid (mainly palm oil), for example;
C₁₈: octadecanedioic acid obtained by biofermentation of stearic acid (a small amount in all vegetable oils but majority in animal fats), for example;
C₂₀: eicosanedioic acid obtained by biofermentation of arachidic acid (majority in rapeseed oil), for example;
C₂₂: docosanedioic acid, obtained by metathesis of undecylenic acid (castor oil), for example;
C₃₆: fatty acid dimer resulting mainly from oleic acid and linoleic acid.

Mention may be made, as examples of anhydrides, of succinic anhydride, maleic anhydride, glutaric anhydride or terephthalic anhydride.

Mention may be made, as examples of aliphatic diamines, of tetramethylenediamine, hexamethylenediamine, 1,10-decamethylenediamine, dodecamethylenediamine, 14-aminotetradecylamine, 16-aminohexadecylamine, 18-aminooctadecylamine or trimethylhexamethylenediamine.

Mention may be made, as examples of cycloaliphatic diamines, of the isomers of bis(4-aminocyclohexyl)methane (BACM or PACM), bis(3-methyl-4-aminocyclohexyl)methane (BMACM or MACM) and 2,2-bis(3-methyl-4-aminocyclohexyl) propane (BMACP), isophoronediamine (IPDA), 2,6-bis(aminomethyl)norbornane (BAMN) and piperazine (Pip).

Mention may also be made, as examples of diamines, as a function of the number x of carbons of the molecule (Cₓ), of:
C₄: butanediamine, obtained by amination of succinic acid by biofermentation;
C₅: pentamethylenediamine (from lysine).

Advantageously, the condensation polymer according to the invention comprises at least one PA block based on PA 4.4, PA 4.6, PA 4.9, PA 4.10, PA 4.12, PA 4.14, PA 4.16, PA 4.18, PA 4.36, PA 6.4, PA 6.6, PA 6.9, PA 6.10, PA 6.12, PA 6.13, PA 6.14, PA 6.16, PA 6.18, PA 6.36, PA 9.4, PA 9.6, PA 9.10, PA 9.12, PA 9.14, PA 9.18, PA 9.36, PA 10.4, PA 10.6, PA 10.9, PA 10.10, PA 10.12, PA 10.13, PA 10.14, PA 10.16, PA 10.18, PA 10.36, PA 10.T, PA BMACM.4, PA BMACM.6, PA BMACM.9, PA BMACM.10, PA BMACM.12, PA BMACM.14, PA BMACM.16, PA BMACM.18, PA BMACM.36, PA PACM.4, PA PACM.6, PA PACM.9, PA PACM.10, PA PACM.12, PA PACM.14, PA PACM.16, PA PACM.18, PA PACM.36, PA Pip.4, PA Pip.6, PA Pip.9, PA Pip.10, PA Pip.12, PA Pip.14, PA Pip.16, PA Pip.18 and/or PA Pip.36, and their mixtures.

According to a second type, the polyamide units result from the condensation of one or more α,ω-aminocarboxylic acids and/or of one or more lactams having from 6 to 12 carbon atoms in the presence of a dicarboxylic acid having from 4 to 12 carbon atoms or of a diamine.

Mention may be made, as examples of lactams, of caprolactam, oenantholactam and lauryllactam.

Mention may be made, as examples of α,ω-aminocarboxylic acids, of aminocaproic acid, 7-aminoheptanoic acid, 11-aminoundecanoic acid and 12-amino-dodecanoic acid.

Advantageously, the polyamide blocks of the second type are made of polyamide 11, of polyamide 12 or of polyamide 6.

According to a third type, the polyamide blocks result from the condensation of at least one monomer of the first type with at least one monomer of the second type. In other words, the polyamide blocks result from the condensation of at least one α,ω-aminocarboxylic acid (or one lactam) with at least one diamine and one dicarboxylic acid.

In this case, the PA units or blocks are prepared by polycondensation:
of the aliphatic, cycloaliphatic or aromatic diamine or diamines having X carbon atoms;
of the dicarboxylic acid or acids having Y carbon atoms; and
of the comonomer or comonomers {Z} chosen from lactams and α,ω-aminocarboxylic acids having Z carbon atoms;
in the presence of a chain limiter chosen from dicarboxylic acids or diamines or of an excess of diacid or diamine used as structural unit.

Advantageously, use is made, as chain limiter, of the dicarboxylic acid having Y carbon atoms, which is introduced in excess with respect to the stoichiometry of the diamine or diamines.

According to another alternative form (case of copolymers, that is to say of copolyamides), the polyamide units result from the condensation of at least two different α,ω-aminocarboxylic acids or of at least two different lactams having from 6 to 12 carbon atoms or of a lactam and of an aminocarboxylic acid not having the same number of carbon atoms in the optional presence of a chain limiter.

Mention may be made, as examples of polyamide units of the third type, of those formed by the following polyamides (copolyamides):
PA 6/6.6, in which 6 denotes caprolactam and 6.6 denotes a monomer resulting from the condensation of hexamethylenediamine with adipic acid.
PA 6.6/Pip.10/12, in which 6.6 denotes a monomer resulting from the condensation of hexamethylenediamine with adipic acid, Pip.10 denotes a monomer resulting from the condensation of piperazine with sebacic acid and 12 denotes lauryllactam.
PA 6.6/6.10/11/12, in which 6.6 denotes a monomer resulting from the condensation of hexamethylenediamine with adipic acid, 6.10 denotes a monomer resulting from the condensation of hexamethylenediamine with sebacic acid, 11 denotes 11-aminoundecanoic acid and 12 denotes lauryllactam.

Mention may also be made, as examples, of PA 10.10/11, PA 6.10/11, PA 10.12/11, PA 10.10/11/12, PA 6.10/10.10/11, PA 6.10/6.12/11 or PA 6.10/6.12/10.10.

Advantageously, the condensation polymer employed in the invention is a block copolymer in the polyether-block-amide form, abbreviated to PEBA.

PEBAs thus include any thermoplastic elastomer comprising at least one polyether block, the latter preferably resulting, at least partially, from THF, such as polytetramethylene glycol or PTMG, and at least one PA (homopolyamide or copolyamide) block as defined above.

Thus, preferably, the PEBA is a block copolymer comprising:
from 1% to 99% of at least one flexible polyether block resulting at least partially from tetrahydrofuran, and
from 1% to 99% of at least one rigid block which is a polyamide block.

Advantageously, said block copolymer comprising at least one flexible polyether block comprises at least one block based on polytetramethylene glycol (PTMG).

Advantageously, said PEBA is based on PA11-PTMG, PA10.10-PTMG, PA10.12-PTMG, PA10.14-PTMG, PA6.10-PTMG, PA6.12-PTMG and/or PA6.18-PTMG, preferably based on PA11-PTMG.

Advantageously, said block copolymer comprising at least one polyether block additionally comprises polyethers other than PTMG, such as PEG, PPG, PO3G or poly(3-methyltetrahydrofuran).

Advantageously, the copolymer according to the invention is a segmented block copolymer comprising three different types of blocks (hereinafter called tribloc), said tribloc being chosen from copolyetheresteramides, copolyetheramideurethanes or copolyetheresterurethanes in which:

the percentage by weight of flexible polyether block is greater than 20%;

the percentage by weight of rigid polyamide block is greater than 10%;

with regard to the total weight of tribloc.

Processes for the synthesis of such a copolymer are known to a person skilled in the art.

Advantageously, the PEBA copolymers comprise PA blocks comprising at least one of the following polyamides PA 11, PA 10.10, PA 10.12, PA 10.14, PA 10.18, PA 6.10, PA 6.12, PA 6.14 or PA 6.18 as predominant components (percentage by weight of greater than 50%, with regard to the total weight of PA) and PE blocks comprising PTMG as predominant component (percentage by weight of greater than 50%, with regard to the total weight of PE) and optionally PO3G as other component of the PE blocks of the PEBA of the invention.

Particularly preferred block copolymers of the invention are PA11-PTMG, PA10.10-PTMG, PA10.12-PTMG, PA10.14-PTMG, PA6.10-PTMG, PA6.12-PTMG, PA6.18-PTMG and/or PA11-PO3G.

Advantageously, the condensation polymer employed in the invention is a grafted copolymer comprising polyamide blocks obtained by reaction of a polyamide having an amine end with the residues of an unsaturated monomer X attached by grafting or copolymerization to a polyolefin backbone.

This monomer X can, for example, be an unsaturated epoxide or an unsaturated carboxylic acid anhydride. The unsaturated carboxylic acid anhydride can be chosen, for example, from maleic anhydride, itaconic anhydride, citraconic anhydride, allylsuccinic anhydride, cyclohex-4-ene-1,2-dicarboxylic anhydride, 4-methylenecyclohex-4-ene-1,2-dicarboxylic anhydride, bicyclo[2.2.1]hept-5-ene-2,3-dicarboxylic anhydride and x-methylbicyclo[2.2.1]hept-5-ene-2,2-dicarboxylic anhydride. Use is advantageously made of maleic anhydride. It would not be departing from the scope of the invention to replace all or part of the anhydride with an unsaturated carboxylic acid, such as, for example, (meth)acrylic acid.

As regards the polyolefin backbone, a polyolefin is defined as a homopolymer or copolymer of α-olefins or of diolefins, such as, for example, ethylene, propylene, 1-butene, 1-octene or butadiene. Mention may be made, as examples, of:
ethylene homopolymers and copolymers, in particular LDPE, HDPE, LLDPE (linear low density polyethylene), VLDPE (very low density polyethylene) and metallocene polyethylene,
propylene homopolymers or copolymers,
ethylene/α-olefin copolymers, such as ethylene/propylene copolymers, EPRs (abbreviation for ethylene/propylene rubber) and ethylene/propylene/diene (EPDM) copolymers,
styrene/ethylene-butene/styrene (SEBS), styrene/butadiene/styrene (SBS), styrene/isoprene/styrene (SIS) or styrene/ethylene-propylene/styrene (SEPS) block copolymers,
copolymers of ethylene with at least one product chosen from salts or esters of unsaturated carboxylic acids, such as alkyl (meth)acrylate (for example methyl acrylate), or vinyl esters of saturated carboxylic acids, such as vinyl acetate, it being possible for the proportion of comonomer to reach 40% by weight.

Advantageously, the polyolefin backbones to which the X residues are attached are polyethylenes grafted by X or copolymers of ethylene and of X which are obtained, for example, by radical polymerization.

As regards the polyethylenes to which X is to be grafted, polyethylene is understood to mean homo- or copolymers.

Mention may be made, as comonomers, of:
α-olefins, advantageously those having from 3 to 30 carbon atoms. Examples have been mentioned above. These α-olefins can be used alone or as a mixture of two or of more than two,
esters of unsaturated carboxylic acids, such as, for example, alkyl (meth)acrylates, it being possible for the alkyls to have up to 24 carbon atoms; examples of alkyl acrylate or methacrylate are in particular methyl methacrylate, ethyl acrylate, n-butyl acrylate, isobutyl acrylate or 2-ethylhexyl acrylate,
vinyl esters of saturated carboxylic acids, such as, for example, vinyl acetate or vinyl propionate,
dienes, such as, for example, 1,4-hexadiene.

The polyethylene can comprise several of the preceding comonomers.

Advantageously, the polyethylene, which can be a mixture of several polymers, comprises at least 50% and preferably 75% (molar) of ethylene; its density can be between 0.86 and 0.98 g/cm³. The MFI (viscosity index at 190° C., 2.16 kg) is advantageously between 20 and 1000 g/10 min.

Mention may be made, as examples of polyethylenes, of:
low density polyethylene (LDPE)
high density polyethylene (HDPE)
linear low density polyethylene (LLDPE)
very low density polyethylene (VLDPE)
polyethylene obtained by metallocene catalysis
EPR (ethylene/propylene rubber) elastomers
EPDM (ethylene/propylene/diene) elastomers
blends of polyethylene with an EPR or an EPDM
ethylene/alkyl (meth)acrylate copolymers which can comprise up to 60% by weight of (meth)acrylate and preferably from 2% to 40%.

The grafting is an operation known per se.

As regards the copolymers of ethylene and of X, that is to say those in which X is not grafted, they are copolymers of ethylene, of X and optionally of another monomer which can be chosen from the comonomers which were mentioned above for the ethylene copolymers intended to be grafted.

Use is advantageously made of ethylene/maleic anhydride and ethylene/alkyl (meth)acrylate/maleic anhydride copolymers. These copolymers comprise from 0.2% to 10% by weight of maleic anhydride and from 0% to 40% and preferably from 5% to 40% by weight of alkyl (meth)acrylate. Their MFI is between 5 and 100 (190° C., 2.16 kg). The alkyl (meth)acrylates have already been described above. The melting point is between 80 and 120° C.

Advantageously, there are on average at least two mol of X per chain which are attached to the polyolefin backbone and preferably from 2 to 5. The person skilled in the art can easily determine, by FTIR analysis, the number of these moles of X. For example, if X is maleic anhydride and the Mw=95 000 g/mol of the polyolefin, it has been found that this corresponds to a proportion of anhydride of at least 1.5% by weight of the whole of the X-comprising polyolefin backbone and preferably from 2.5% to 4%. These values, in combination with the weight of the polyamides comprising an amine ending, determine the proportion of polyamide and of backbone in the grafted copolymer comprising polyamide blocks.

As regards a polyamide comprising an amine end, the term “polyamide” is understood to mean the products mentioned above in a).

The Supramolecular Polymers

The reactants used in the manufacture of the supramolecular polymers employed in the composition according to the invention will now be described in more detail.

As indicated above, the supramolecular polymer is capable of being obtained by the reaction of at least one at least trifunctional compound (A) carrying first and second functional groups with:
at least one compound (B) carrying, on the one hand, at least one reactive group capable of reacting with the first functional groups of (A) and, on the other hand, at least one associated group; and
at least one at least bifunctional compound (C), the functional groups of which are capable of reacting with the second functional groups of the compound (A) in order to form ester or thioester or amide bridges.

The term “associative groups” is understood to mean groups capable of associating with one another via hydrogen bonds, advantageously via from 1 to 6 hydrogen bonds. Examples of associative groups which can be used are the imidazolidinyl, triazolyl, triazinyl, bis-ureyl or ureido-pyrimidyl groups. It is preferable for the mean number of the terminal associative groups per molecule of the supramolecular polymer to be at least 3. It is advantageously at most 6. These are connected covalently to the molecule. The term “covalently” is understood to mean that the associative groups are connected to the terminal functional groups of the molecule either via a direct bond or, preferably, via a chain, in particular an alkylene chain.

The term “reactive groups” or “functional groups” is understood to mean chemical functional groups capable of reacting with other chemical functional groups to form covalent bonds, resulting in particular in the formation of ester, thioester, amide, urea or urethane bridges and especially ester and amide bridges. A “bifunctional” compound denotes a compound carrying two identical or different reactive functional groups. An “at least trifunctional” compound denotes a compound carrying at least three identical or different reactive functional groups.

The term “fragment” is understood to mean, within the meaning of the invention, a unit of a molecule located between two or three bridges as defined above. A “bifunctional” fragment is capable of being obtained from a bifunctional compound and a “trifunctional” fragment is capable of being obtained from a trifunctional compound. The molecules of the supramolecular polymer comprise at least bifunctional fragments, advantageously bifunctional fragments, and at least trifunctional fragments, advantageously trifunctional fragments.

Preferably, the compound (A) represents more than 50% by weight, with respect to the total weight of the supramolecular polymer.

The compound (A) employed in the first stage of the process for the synthesis of the supramolecular polymer can in particular carry at least three identical or different functional groups chosen from acid, ester or acyl chloride functional groups. It advantageously comprises from 5 to 100, preferably from 12 to 100 and more preferably from 24 to 90 carbon atoms.

The compound (A) can, when it is reacted with the compound (B) and/or the compound (C), occur as a mixture with mono- and bifunctional compounds, such as mono- and diacids, in particular mono- and dimers of fatty acids.

It is preferable to use, according to the invention, as compound (A), the mixtures of dimers (oligomers of 2 identical or different monomers) and trimers of fatty acids of vegetable origin. The compound (A) can thus be a trimer of at least one of the following acids: undecylenic acid, myristoleic acid, palmitoleic acid, oleic acid, linoleic acid, linolenic acid, ricinoleic acid, eicosenoic acid and docosenoic acid, which are normally found in pine oil (tall oil fatty acids), rapeseed oil, corn oil, sunflower oil, soybean oil, grape seed oil, linseed oil or jojoba oil, and also eicosapentaenoic acid and docosahexaenoic acid, which are found in fish oils.

The compound (A) can be a mixture of fatty acid trimer and of diacids chosen from a linear alkanedicarboxylic acid, such as glutaric acid, adipic acid, pimelic acid, suberic acid, azeleic acid, sebacic acid, undecanedioic acid, dodecanedioic acid, brassylic acid, tetradecanedioic acid, pentadecanedioic acid, thapsic acid or octadecanedioic acid, or a branched alkanedicarboxylic acid, such as 3,3-dimethyl glutaric acid.

Mention may be made, as examples of fatty acid trimers, of the compounds having the following formulae, which illustrate the cyclic trimers resulting from fatty acids comprising 18 carbon atoms, it being known that the commercially available compounds are mixtures of steric isomers and of positional isomers of these structures, optionally partially or completely hydrogenated.

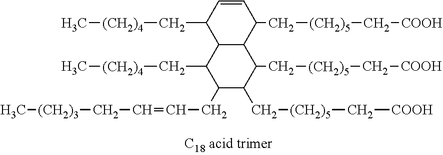

Use may thus be made of a mixture of fatty acid oligomers comprising dimers, trimers and monomers of linear or cyclic C₁₈ fatty acids, said mixture being predominant in dimers and trimers and comprising a low percentage (usually less than 5%) of monomers. Preferably, the said mixture comprises:
from 0% to 40% by weight, preferably from 0.1% to 5% by weight, of monomers of fatty acids which are identical or different,
from 0.1% to 99% by weight, preferably from 18% to 85% by weight, of dimers of fatty acids which are identical or different, and
from 0.1% to 90% by weight, preferably from 5% to 85% by weight, of trimers of fatty acids which are identical or different.

More preferably still, said mixture of molecules which are derived from fatty acids has an average molecular weight of greater than 400 g/mol.

Mention may be made, as examples of mixtures of dimers and trimers of fatty acids (% by weight), of:
Pripol® 1017 from Croda [NB: Uniqema has become Croda], mixture of 75-80% dimers and 18-22% trimers with of the order of 1-3% monomeric fatty acids,
Pripol® 1048 from Croda, 50/50% mixture of dimers/trimers,
Pripol® 1013 from Croda, mixture of 95-98% dimers and 2-4% trimers, with a maximum of 0.2% of monomeric fatty acids,
Pripol® 1006 from Croda, mixture of 92-98% dimers and of a maximum of 4% trimers, with a maximum of 0.4% monomeric fatty acids,
Pripol® 1040 from Croda, mixture of fatty acid dimers and trimers with at least 75% trimers and less than 1% monomeric fatty acids,
Unidyme® 60 from Arizona Chemicals, mixture of 33% dimers and 67% trimers with less than 1% monomeric fatty acids,
Unidyme® 40 from Arizona Chemicals, mixture of 65% dimers and 35% trimers with less than 1% monomeric fatty acids,
Unidyme® 14 from Arizona Chemicals, mixture of 94% dimers and less than 5% trimers and other higher oligomers with the order of 1% monomeric fatty acids,
Empol® 1008 from Cognis, mixture of 92% dimers and 3% higher oligomers, essentially trimers, with the order of 5% monomeric fatty acids,
Empol® 1018 from Cognis, mixture of 81% dimers and 14% higher oligomers, essentially trimers, with the order of 5% monomeric fatty acids,
Radiacid® 0980 from Oleon, mixture of dimers and trimers with at least 70% trimers,
Radiacid® 0950 from Oleon, mixture of 79-85% fatty acid dimers and 13-19% fatty acid trimers with the order of 1-3% monomeric fatty acids.

The products Pripol®, Unidyme®, Empol® and Radiacid® comprise C₁₈ fatty acid monomers and fatty acid oligomers corresponding to multiples of C₁₈.

According to a specific embodiment, the dicarboxylic acid and tricarboxylic acid mixture can be partially or completely replaced with a derivative of diacid(s) and triacid(s), this derivative being chosen from an acid salt, an acid ester and an acid chloride.

Mention may be made, as examples of ester, of a methyl, ethyl or isopropyl ester of a fatty acid as defined above.

A preferred fatty acid ester is a fatty acid methyl ester and in particular a methyl ester of fatty acid dimer or of a mixture of fatty acid oligomers as defined above.

Mention may be made, as example of fatty acid chloride, of sebacoyl chloride.

For its part, the compound (B) carries at least one reactive group which can in particular be chosen from primary or secondary amine or alcohol groups. In an alternative form, the compound (B) can carry at least two such identical or different groups. It is preferable, according to the invention, for the compound (B) to carry at least one primary amine functional group.

In the case in particular where the reactive group of the compound (B) is capable of reacting both with the first and second functional groups of the compound (A), it is preferable, in the first stage of the process, for the ratio of the number of the reactive groups of the compound (B) to the sum of the functional groups of the compound (A) to range from 0.05 to 0.8 and preferably from 0.15 to 0.7.

The compound (B) can thus correspond to any one of the formulae (B1) to (B5):

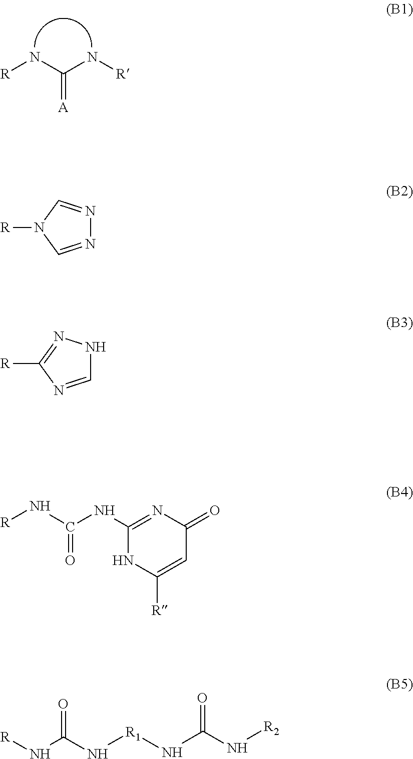

where:

R denotes a unit comprising at least one reactive functional group,

R′ denotes a hydrogen atom,

R″, R₁ and R₂ denote any group,

A denotes an oxygen or sulfur atom or an —NH group, preferably an oxygen atom.

Preferred examples of compounds (B) are 2-aminoethylimidazolidone (UDETA), 1-(2-[(2-aminoethyl)amino]ethyl)imidazolidone (UTETA), 1-(2-[2-{2-aminoethyl-amino}ethylamino]ethyl)imidazolidone (UTEPA), N-(6-aminohexyl)-N′-(6-methyl-4-oxo-1,4-dihydropyrimidin-2-yl)urea (UPy), 3-amino-1,2,4-triazole and 4-amino-1,2,4-triazole. UDETA is preferred for use in the present invention.

Some of these compounds can be obtained by reaction of urea with a polyamine. For example, UDETA, UTETA and UTEPA can be respectively prepared by reacting urea with diethylenetriamine (DETA), triethylenetetramine (TETA) and tetraethylenepentamine (TEPA).

The reaction of the compound (B) with the compound (A) can, for example, be carried out at a temperature between 20 and 200° C., preferably between 130 and 170° C., for a period of time ranging from 1 to 15 h, for example from 3 to 9 h, advantageously with stirring and under an inert atmosphere.

This compound is then reacted with an at least bifunctional compound (C), so that the functional groups of (C) react with the second functional groups, that is to say the remaining reactive functional groups, of the compound (A). In this stage, the imposition of catalytic conditions liable to result in a homopolymerization of the compound (C) will be avoided.

The compound (C) carries at least two identical or different functional groups chosen in particular from epoxy, alcohol and amine functional groups.

The compound (C) can be a diepoxide. It can thus be chosen from: bisphenol A diglycidyl ether, bisphenol F diglycidyl ether or tetrabromobisphenol A diglycidyl ether, or hydroquinone diglycidyl ether, ethylene glycol diglycidyl ether, propylene glycol diglycidyl ether, butylene glycol diglycidyl ether, neopentyl glycol diglycidyl ether, 1,4-butanediol diglycidyl ether, 1,6-hexanediol diglycidyl ether, cyclohexanedimethanol diglycidyl ether, polyethylene glycol diglycidyl ether, polypropylene glycol diglycidyl ether, polytetramethylene glycol diglycidyl ether, resorcinol diglycidyl ether, neopentyl glycol diglycidyl ether, bisphenol A polyethylene glycol diglycidyl ether, bisphenol A polypropylene glycol diglycidyl ether, terephthalic acid diglycidyl ester, epoxidized polyunsaturated fatty acids and epoxidized limonene; and their mixtures.

In an alternative form, the compound (C) can be a polyepoxide including at least three epoxide functional groups chosen, for example, from: castor oil triglycidyl ether, 1,1,1-tris(hydroxymethyl)propane triglycidyl ether, trisphenol triglycidyl ether, glycerol triglycidyl ether, glycerol propoxylate triglycidyl ether, glycerol ethoxylate triglycidyl ether, trimethylolpropane triglycidyl ether, sorbitol polyglycidyl ether, polyglycerol polyglycidyl ether, pentaerythritol polyglycidyl ether, polyglycidyl acrylate), polyglycidyl methacrylate, epoxidized polyunsaturated fatty acids, epoxidized vegetable oils, epoxidized fish oils and epoxidized limonene.

In another alternative form, the compound (C) can be a diol. In this case, the compound (C) can be chosen from: ethylene glycol, propylene glycol, tetramethylene glycol, hexamethylene glycol, octanediol, nonanediol, decanediol, diethylene glycol, dipropylene glycol, triethylene glycol, tetraethylene glycol, polyethylene glycol, polypropylene glycol, polytetramethylene glycol, polyesters having hydroxyl ends, polybutadienes having hydroxyl ends, polydimethylsiloxanes having hydroxyl ends, polyisobutylenes having hydroxyl ends, polybutadiene-co-acrylonitrile copolymers having hydroxyl ends, dimer diols resulting from fatty acids, and their mixtures.

According to another possibility, the compound (C) can be a polyol including at least three alcohol functional groups. Examples of such compounds are in particular: sugars, such as sorbitol, pentaerythritol, trimethylolpropane, and also glycerol and its ethoxylated and propoxylated derivatives, castor oil and the dimer diols resulting from fatty acids, such as Pripol 2033 from Croda.

According to another possibility, the compound (C) can be a polyamine. The polyamine can be any compound carrying at least two amine functional groups, preferably a primary amine and preferably a compound of formula (I):

H₂N—(CHR₁)ₘ—(CHR₂)ₙ—[NH—(CH₂)ₓ]_{y}—NH—(CHR₃)ₚ—(CHR₄)_{q}—NH₂ (I)

in which:

R₁, R₂, R₃ and R₄ independently denote a hydrogen atom or a C₁-C₆ alkyl group, such as a methyl group,

m, n, p and q independently denote an integer ranging from 1 to 3,

x denotes an integer ranging from 1 to 6,

y denotes an integer ranging from 0 to 2.

In the above formula (I), at least one and preferably all of the following conditions are satisfied:
R₁, R₂, R₃ and R₄ denote a hydrogen atom,
m+n is equal to 2, 3 or 6, preferably to 2,
p+q is equal to 2, 3 or 6, preferably to 2,
x denotes an integer ranging from 2 to 4,
y is equal to 0 or 1, preferably to 0.

Preferred examples of polyamines of formula (I) are DETA (diethylenetriamine), TETA (triethylenetetramine), TEPA (tetraethylenepentamine) and dihexylenetriamine.

In an alternative form, the polyamine can be a linear alkylenediamine comprising from 3 to 40 carbon atoms, such as cadaverine, putrescine, hexamethylenediamine or 1,12-diaminododecane, or a cyclic alkylenediamine, such as isophoronediamine.

The reaction of the polyamine (compound (C)) with the dicarboxylic/tricarboxylic acid mixture or their salt, ester or acid chloride derivatives used (compound (A)) can, for example, be carried out at a temperature between 20 and 200° C., preferably between 140 and 180° C., for a period of time ranging from 1 to 24 h, for example from 6 to 8 h, advantageously with stirring and under an inert atmosphere.

In a preferred embodiment, the compound (A) is a mixture of polycarboxylic acids or its salt, ester or acid chloride derivative reacted with at least one compound (C) which is a polyamine in a molar ratio of the amine functional groups to the acid functional groups of the dicarboxylic acid between 0.95 and 0.02 and preferably between 0.85 and 0.3.

The supramolecular polymer employed in the compositions which are subject matters of the invention results from the reaction of the compound (A) with the compound (B) and with the compound (C). These reactions can be carried out simultaneously or successively. In the case where these reactions are carried out successively, the reaction of the compound (A) with the compound (B) will preferably be carried out first but the reverse order is also possible. In addition, they can be carried out either in separate reactors or in the same reactor, without it being necessary to provide a washing or purification stage after the first of these reactions.

It is preferable for the supramolecular polymer to also include intermolecular hydrophobic bonds, advantageously due to interactions between alkyl groups carried by each of the trifunctional molecules described above. The term “alkyl” is understood to mean, within the meaning of the invention, side groups (CₙH₂ₙ₊₁) and not alkylene chains (CₙH₂ₙ), for example. Particularly preferably, each of these molecules comprises C₆-C₂₄ alkyl chains, advantageously in a greater number than said terminal associative groups. They can in particular be contributed by the compounds (A), in particular when they are fatty acid trimers.

In a specific embodiment, the supramolecular polymer defined above is reacted with urea.

Thus, preferably, the product resulting from the reaction of at least one compound (A) with at least one compound (B) and at least one compound (C) is reacted with urea in order to form di(amidoethyl)urea, diamidotetraethyltriurea and/or urea junctions.

The reaction can, for example, be carried out at a temperature of 110 to 180° C., preferably of 120 to 160° C., a temperature gradient being produced, for a period of time ranging from 30 minutes to 24 h, preferably for a period of time of 1 to 6 hours, under an inert atmosphere and, advantageously, with stirring. Here again, this reaction can be carried out in a separate reactor from that or those used in the preceding stage or stages, or in the same reactor. It is thus understood that all the stages of the process for producing the supramolecular polymer can be carried out in the same reactor, by successive addition of the reactants, which renders the process particularly simple and economic.

The urea has the role, in this stage, of creating additional associative groups, for example according to the following reaction schemes:

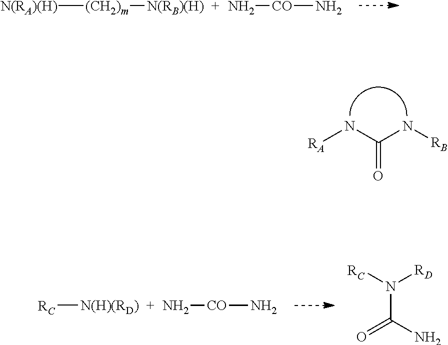

The compounds (A), (B) and (C) described above can be introduced in the molten state, in the pulverulent or nonpulverulent solid state or by the liquid route, for example in aqueous solution or dispersion. However, it is preferable for them to be introduced in the pulverulent solid state or in the molten state in order to avoid resorting to solvents which subsequently have to be removed.

When the process for producing the supramolecular polymer comprises a final stage of reaction with the urea, thus, in addition to the reactions of (A) with (B) and (C), it is preferable for the compound (C) to be a polyamine as described above and it is particularly preferable for the compound (C) to be diethylenetriamine or DETA.

The proportions of (A), (B) and (C) used in the process for the synthesis of the supramolecular polymer, and also their nature, and the choice of carrying out or not carrying out an additional stage of reaction with urea determine the mechanical characteristics of said polymer. Thus, it is possible to obtain mechanical properties ranging from those of an elastomer to those of a plastomer. These parameters also determine the solubility properties of said polymer. Thus, it is possible for the supramolecular polymer to be completely or partially soluble in polar solvents, such as alcohols.

According to one embodiment of the invention, the mean number of associative groups per molecule is at least 1.2, preferably at least 2, indeed even at least 2.2.

The supramolecular polymers employed in the compositions which are subject matters of the invention advantageously exhibit elastomeric properties, such as that of rubber elasticity or hyperelasticity, that is to say the property of being able to be subjected to a uniaxial strain at its temperature of use, for example at ambient temperature, of at least 20%, for example for 15 minutes, and of recovering, once this stress has been released, most of its initial dimension, for example, with a set of less than 5% of its initial dimension.

These supramolecular polymers can, furthermore, be capable of self-healing after cutting and can exhibit, after bringing the edges of the cut back into contact, properties which are still elastomeric, allowing them to be subjected, for example, to a tensile strain of at least 20%, indeed even at least 100%, before failure and of recovering most of their initial dimensions once the stress has been released, with, for example, a set of less than 10% of their initial dimension.

The supramolecular polymers defined above are materials in the form of soft solids which must be extracted from the reactor used to synthesize them. According to a preferred alternative form, the product can be extracted from the reactor in the liquid state and “finished” by a heat treatment in an oven or furnace or using heating tapes or any other suitable equipment, until it has been converted into a soft solid. The supramolecular polymer can be cut up or ground, in particular under cold conditions, for example in a hammer, bead, bowl, edge runner or knife mill, then washed, for example with water, and optionally formed, in particular by hot pressing, calendering, thermoforming or any other method.

Preferably, the supramolecular polymer, optionally washed with water, is cut up roughly into strips or pieces.

### Additives

The composition which is a subject matter of the invention can be used as is or in single-phase or multiphase mixtures with one or more compounds, such as petroleum fractions, solvents, inorganic and organic fillers, plasticizers, tackifying resins, processing aids, lubricants, antioxidants, antiradiation (anti-UV) additives, pigments and/or dyes.

In particular, additives capable of being added to the composition according to the invention are especially:
lubricants, such as stearic acid and its esters, waxy esters, polyethylene waxes, paraffin or acrylic lubricants,
dyes,
inorganic or organic pigments, such as those described in the document “Plastics Additives and Modifiers Handbook, Section VIII, Colorants”, J. Edenbaum, Ed., Van Nostrand, pages 884-954. Mention may be made, as examples of pigments which can be used, of carbon black, titanium dioxide, clay, metal particles or treated mica particles of the Iriodin® brand sold by Merck,
plasticizers, such as esters, for example phthalates or adipates, ethers, for example dimethylisosorbide, or amides,
heat and/or UV stabilizers, such as tin stearate, lead stearate, zinc stearate, cadmium stearate, barium stearate or sodium stearate, including Thermolite® from Arkema,
costabilizers, such as epoxidized natural oils,
antioxidants, for example phenolic, sulfur-comprising or phosphite antioxidants,
fillers or reinforcing agents, in particular cellulose fillers, talc, calcium carbonate, mica or wollastonite, glass, metal oxides or hydrates, carbon black or silica,
antistatic agents,
fungicides and biocides,
blowing agents used for the manufacture of expanded parts, such as azodicarbonamides, azobisisobutyronitrile or diethyl azobisisobutyrate,
flame retardants, including antimony trioxide, zinc borate and brominated or chlorinated phosphate esters,
solvents, and
their mixtures.

Preferably, the composition which is the subject matter of the invention comprises at least one inorganic filler, such as silica, calcium carbonate, talc or titanium dioxide. The presence of a filler in the compositions which are subject matters of the invention makes it possible to improve their capability to be employed in industrial processes comprising a stage of injection into a mold while reducing the degree of shrinkage.

The composition which is the subject matter of the invention can be used in particular to manufacture generally all the objects requiring a stage of injection molding. They can, for example, be:
Toys: figurines, characters and dolls, assembly game parts, models, bodies and parts of rolling, floating or flying games, decorative parts, or educational models and equipment,
Items of pleasure: coat racks, coat hangers, office accessories, bodies and coverings of pens, keyrings, cases, cosmetic packagings, corner protections for boxes and baggage, guitar plectrums, combs, garden tables or spectacles,
Utilitarian accessories: crates, hampers, lockers, bins, tool boxes, tool handles, brooches and necklaces, corner protections, shoes, soles, stone guards, sports protective shells, helmet linings, bicycle pedals, cups, bowls, buckets, containers, serving trays, ice scrapers, brushes, scrapers, stoppers or bottles,
Pharmaceutical accessories: seals, septa, membranes, connectors, valves, flasks,
Parts for the electrical goods industry and the electrical tools industry: shells, structures, equipment frames, leaktight and insulation seals (dust, water),
Parts for the electronics industry: casings for screens, for telephones, for keyboards, for personal computers or for mice, casings and plugs for connectors, for buttons, keyboard keys, grommets (sealing washers cable bushings), casings for earphones, for loudspeakers, ventilation slots, extractors (of hot air),
Parts for the electrical equipment industry: control panels, strip lights, branch boxes, regulating plugs and controls, electric boards, frames for electrical components, such as electromagnets, contactors, transformers, changeover switches, insulators for electric fences, cable jackets, joints,
Parts for the motor vehicle industry: interior fittings for doors, body shells for dashboards, for central consoles, drawers, lids and hinges of lids and boxes, storage cases, mountings for sun visors, mountings for mirrors, air and air conditioning vents, helices, grills, parts participating in devices for oil separation, for admission of air, mountings for nets, seat shelves, side and back protections of seats, covers for mountings, handles, combination controls, lighting boxes, fuse boxes, covering caps or compartments for electrical or electronic accessories in the engine compartment or passenger compartment (light sensors, rain sensors), grommets (=cable bushings), washers, valves, flaps, connections for fuels, for power steering, for oil circuit, insulating caps and plugs, clips, lighting (headlamps) adjusting systems, clutch acoustic closing covers. Wheels, rollers, gearing, stops, pads. Fenders for tractors, trailers and power-driven cultivators. Tanks for fluids,
Accessories for the construction industry: clips for sheaths, dowel pins, screw plugs, clips for gratings, accessories for aluminum carpentry, cable bushings and connection units,
Parts for industry: stiffening components, pallet truck rollers, casters,
Parts for the furniture industry: flexible treads for casters, ferrules, closing covers, buttons, handles, pads, nut covers, cable bushings, fitting inserts, corner protectors, wedges, stops, anatomical seat shells, arm rests.

Another subject matter of the invention is the use of the composition which is a subject matter of the invention for the abovementioned purposes.

Processes which are Subject Matters of the Invention

The supramolecular polymers as defined above can be mixed and coground (ground together) with the chosen condensation polymers or, preferably ground and then mixed with the chosen condensation polymer(s) obtained in the form of granules or of powder and optionally with fillers (such as silica) and other additives, so as to obtain a mixture in the form of granules or powder comprising both types of polymer.

Preferably, the grinding stage is carried out at low temperature (cryogenic grinding), that is to say below ambient temperature (between −175° C. and ambient temperature).

According to another method of manufacture, the supramolecular polymer(s) is (are) mixed with the condensation polymer or polymers in any device for processing polymers, such as, for example, an open mill (calander), an internal mixer, an extruder, a compression molding press, and the like, it being possible for the mixture to be recovered, for example, in the form of granules, sheets, films, shreds, pieces, strips, rods, balls, crepes, and the like. The mixture thus obtained can subsequently be cut up or ground in order to obtain a physical form suitable for the feeding of an injection molding machine. The preferred physical forms are those of granules, powders, rods or strips.

According to a third method of manufacture, the condensation polymer or polymers intended for the mixing, alone or with other additives, such as silica, can be introduced during any one of the stages of synthesis of the supramolecular polymers as described above. When this is the case, the preferred way is to introduce the condensation polymer or polymers into the synthesis reactor with the initial starting materials, that is to say, before even the first chemical reaction stage has finished. The synthesis of the supramolecular polymer takes place, in this case, in the presence of the condensation polymer(s). The synthesis stages described above for the supramolecular polymers according to the invention thus follow on from one another, in the presence of the condensation polymer, and the final solid mixture is recovered in the form of sheets, balls, beads, pieces, crepes, and the like. The mixture in this form can be subjected to stages of grinding, homogenization, mixing with other additives, and the like, provided that its final form is suitable for the feeding of an injection molding machine. Thus, for example, the mixture resulting from the synthesis in the form of sheets can be cut up and then cryogenically ground in order to obtain a powder or granules which make possible the feeding of conventional injection molding machines.

A further subject matter of the invention is thus a process for the manufacture of a composition, said process comprising:
a stage of reaction of at least one at least trifunctional compound (A) carrying first and second functional groups with at least one compound (B) carrying, on the one hand, at least one reactive group capable of reacting with the first functional groups of (A) and, on the other hand, at least one associative group;
a stage of reaction of at least one at least bifunctional compound (C), the functional groups of which are capable of reacting with the second functional groups of the compound (A) to form ester, thioester or amide bridges,
optionally a stage of reaction with urea, and
a stage of addition of a thermoplastic condensation polymer as defined above, before, during or after any one of the above stages.

Each reaction stage mentioned above can be followed by a stage of heat treatment at a temperature between 100° C. and 250° C. for a time ranging from 1 hour to 5 days at a pressure between 300 mbar and 1 bar.

As indicated above, these reactions can be carried out simultaneously or successively. In the case where these reactions are carried out successively, the reaction of the compound (A) with the compound (B) will preferably be carried out first but the reverse order is also possible. In addition, they can be carried out either in separate reactors, or in the same reactor, or in reactors and then ovens, autoclaves or other equipment in which the reactions will result in the physical transformation of the products into soft solids.

A better understanding of the invention will be obtained in the light of the following examples, given only for illustrative purposes and which are not intended to restrict the scope of the invention, defined by the appended claims.

### EXAMPLES

### Example 1

### Preparation of a supramolecular polymer A

First stage:

Substage a:

76 g of Empol® 1016 [acid number 194, content of monomer (4%), dimer (80%), trimer (16%)] and 6.7 g of purified UDETA (52 mmol), i.e. an [NH₂]/[COOH] ratio of 0.2, are introduced into a reactor, preheated to 40° C., with a diameter of 60 mm and nominal volume of 500 ml equipped with a bottom valve, temperature regulation by a heat-exchange fluid, a mechanical stirrer, a dropping funnel, a Dean & Stark apparatus and a gas inlet. The temperature of the bath is brought to 150° C. for 8 hours under a stream of nitrogen of 500 ml/minute and stirring at 280 revolutions/min. During this stage, the decrease in the signal of δNH₂ (1505 cm⁻¹) and the increase in the vC═O signal (1648 cm⁻¹) are observed by infrared spectroscopy, and the release of water vapor is observed. The decision to halt the reaction is taken when release of water vapor ceases (8 hours in the present example).

After this substage, the reaction product is stored at 50° C. in the reactor.

Substage b:

The same setup and the same conditions (nitrogen, stirring) as above are used. 10.7 g (104 mmol) of diethylenetriamine (purity 98%) are placed in the dropping funnel.

The body of the reactor is heated to 160° C. and the amine is slowly added dropwise intermittently over a total period of time of 3 h. The reaction is allowed to continue for a further 4 h at 160° C. During this second stage, the same type of change as above is observed by infrared spectroscopy. The end of the release of water vapor, again observed here, is used as criterion for halting the reaction.

After this stage, the product is collected via the bottom valve (86 g are collected) and stored at ambient temperature. It exists as a viscoelastic liquid which is strongly adhesive on numerous substrates, in particular on glass, on metal and on paper. The glass transition temperature, measured by DSC (differential scanning calorimetry), is −11° C. Rheological measurements carried out in parallel plate geometry with an applied strain of 1% have provided, at the stressing frequency of 1 rad/s, the following results:

| | T (° C.) | | | | |
|---|---|---|---|---|---|
| | 25 | 35 | 50 | 70 | 90 |
| G′(Pa) | 33 078 | 9812 | 1884 | 234 | 34 |
| G″ Pa) | 49 311 | 17 568 | 4695 | 947 | 225 |

Second Stage:

67 g of the preceding product and 6.1 g of urea are introduced into a broad reactor, preheated to 80° C., (diameter 100 mm) with a nominal volume of 500 ml equipped with temperature regulation by a heat-exchange fluid, a mechanical stirrer and a gas inlet. The stirring is adjusted to 50 revolutions/min and the temperature is brought to 135° C. After half an hour at this temperature and throughout the continuation of the process, a sizable release of ammonia is observed using a pH indicator paper. Throughout this stage, the monitoring of the reaction by infrared spectroscopy reveals the decrease in the signal of urea vC═O 1675 cm⁻¹.

The temperature is maintained for a total of two hours at 135° C., then 1 hour at 140° C. and then one hour at 145° C. At this stage, it is found that the reaction mixture, initially cloudy, tends to become transparent. One gram of water is added and the solution becomes cloudy again. The mixture is brought to 150° C. for a further 1 h approximately, during which a decrease in the release of ammonia is observed.

The criterion for halting is this time that the product sets solid and clings on to the shaft of the stirrer. As soon as this is the case, the product is collected on the stirrer rod.

Forming:

The pieces obtained are placed in a plastic bag and ground under cold conditions using a hammer. The fragments with a size of from 1 to 2 mm are washed by immersion in water for 72 h. In the water, the fragments subjected to washing have a tendency to stick to one another. The sample, drained beforehand, is cut up again into pieces with a size of approximately 5 mm, which are placed in a mold composed of a brass plate with a thickness of 1.6 mm pierced by a rectangular hole, which plate is placed between two sheets of nonstick paper. After a first pressing at 120° C. for 10 minutes (applied pressure 10 MPa), the film obtained exhibits irregularities in thickness which are corrected by addition of material and repressing until a satisfactory appearance is obtained.

### Example 2

### Preparation of a Supramolecular Polymer B

1000 g of Pripol® 1040 from Uniqema® (acid number 186), i.e. 3.32 mol of carboxylic acid, and 245 g of UDETA having a purity of 87.6% by weight, i.e. 1.66 mol of amine, are introduced into a Schott reactor with a working volume of 4000 ml positioned on an electrical heating mantle and equipped with a temperature probe, a mechanical stirrer with a polytetrafluoroethylene rotor of anchor type, a dropping funnel, a reflux condenser, a Dean & Stark apparatus and a nitrogen inlet terminated by a polytetrafluoroethylene dip pipe. It is assumed that the impurities of the UDETA can contribute the equivalent of an additional 0.13 mol. The mixture is heated at 170° C. in order to remove the water of condensation. When the water of condensation has been removed and trapped in the Dean & Stark apparatus, the medium is cooled to 80° C. 294 g of an epoxy resin of BADGE type, Epikote® 828 EL from Resolution® (epoxy content of 5.2 mol/kg), i.e. 1.53 mol, are added at 80° C. and the mixture is left stirring at 80° C. for 15 minutes. The product thus obtained is emptied from the reactor and can be stored without heat treatment in polypropylene containers. In order to obtain the final material, a heat treatment can be carried out in an oven at 120° C. for 24 hours, preferably as a layer with a thickness of 5 mm on a nonadherent support, such as plates covered with polytetrafluoroethylene.

### Example 3

Four compositions were used in example 3. a) A Pebax® 2533 supplied by Arkema, which is a condensation polymer, b) a supramolecular polymer (A) obtained according to example 1, charged with 10% by weight of amorphous silica Ultrasil® VN3 from Evonik, c) a mixture of supramolecular polymer (A) charged with 10% by weight of silica, mixed with 10% by weight of Pebax® 2533, i.e. a mixture of 81% by weight of the supramolecular polymer (A), 9% by weight of silica and 10% by weight of Pebax®, and d) a mixture of supramolecular polymer (A) charged with 10% by weight of silica, mixed with 20% by weight of Pebax® 2533, i.e. a mixture of 72% by weight of the supramolecular polymer (A), 8% by weight of silica and 20% by weight of Pebax®. The 4 compositions were mixed for 10 minutes in a microextruder of DSM brand with a capacity of 15 cm³ and provided with a recirculation channel, the material temperature is measured at 142-144° C. following the tests, and the speed of the screws is set at 100 rpm. The 3 compositions, recovered in the form of rods, are subsequently cut up into granules and injected into a mold using a micro injection molding machine of DSM brand. The temperature of the piston is set at 160° C. and that of the mold at 25° C. The injection cycle is, 5 bar for 1 second, rise to 10 bar over 3 seconds and maintenance at 10 bar for 5 seconds. The mold makes it possible to produce test specimens in accordance with the standard ISO 527 18A. Measurements of shrinkage after injection are carried out by comparing the nominal length of the mold for test specimens with the length of the injected product after an “equilibration” time of 3 days, during which the test specimens are kept at ambient temperature.

Qualitative measurements of healing are carried out by cutting a test specimen into two, by sticking it back together and by leaving to heal for a time ranging from one hour to 24 hours; the healed test specimens are subsequently drawn and their strengths (qualitative estimation of the force necessary to break them again, qualitative or quantitative estimation of the strain undergone at break) are compared after an identical healing time for all the test specimens to be compared in one and the same series. A grading ranging from − (no healing) to +++ (very good healing) is given to each test specimen. The results of the measurements of shrinkage and healing appear in table 1 below:

TABLE 1

| Composition | Length | Shrinkage | Healing |
|---|---|---|---|
| Pebax ® 2533 | 7.5 | 0% | − |
| 90% Polymer (A) | 5 | 33% | +++ |
| 10% Silica | | | |
| 81% Polymer (A) | 7 | 7% | ++ |
| 9% Silica | | | |
| 10% Pebax ® 2533 | | | |
| 72% Polymer (A) | 7 | 7% | + |
| 8% Silica | | | |
| 20% Pebax ® 2533 | | | |

### Example 4

Mixtures are produced according to the same conditions as in example 3, using the following products:
Pebax® 2533: polyether-block-amides sold by Arkema.
Polymer B: supramolecular polymer of example 2
Silica: amorphous silica sold under the name Ultrasil® VN3 by Evonik.
SBS: Styrene/Butadiene/Styrene copolymer sold under the name Evoprene® by Alphagary
HX2656: Polyamide sold under the name Platamid® by Arkema
Apolhya®: grafted copolymer comprising polyamide blocks sold under the name Apolhya® by Arkema
3345 PV: Ethylene/vinyl acetate copolymer sold under the name Evatane® by Arkema
24 MA 07: Copolymer sold under the name Lotryl® by Arkema.

The formulations and test results appear in table 2 below.

TABLE 2

| Composition | Length (cm) | Shrinkage | Healing |
|---|---|---|---|
| Pebax ® 2533 | 7.5 | 0% | − |
| SBS | 7.3 | 3% | − |
| 90% Polymer B | 5.3 | 29% | +++ |
| 10% Silica | | | |
| 76.5% Polymer B | 5.3 | 29% | +++ |
| 8.5% Silica | | | |
| 15% SBS | | | |
| 76.5% Polymer B | 7 | 7% | ++ |
| 8.5% Silica | | | |
| 15% HX2656 | | | |
| 76.5% Polymer B | 6.6 | 12% | +++ |
| 8.5% Silica | | | |
| 15% Apolhya ® | | | |
| 72% Polymer B | 7.2 | 4% | +++ |
| 8% Silica | | | |
| 20% Apolhya ® | | | |
| 76.5% Polymer B | 6.5 | 13% | − |
| 8.5% Silica | | | |
| 15% 3345 PV | | | |
| 76.5% Polymer B | 6.4 | 15% | − |
| 8.5% Silica | | | |
| 15% 24 MA 07 | | | |
| 81% Polymer B | 7.2 | 4% | ++ |
| 9% Silica | | | |
| 10% Pebax 2533 | | | |
| 76.5% Polymer B | 7.3 | 3% | ++ |
| 8.5% Silica | | | |
| 15% Pebax 2533 | | | |
| 72% Polymer B | 7.3 | 3% | + |
| 8% Silica | | | |
| 20% Pebax 2533 | | | |

It is observed that some compositions do not make it possible to have an acceptable shrinkage (SBS), others exhibit a lower shrinkage but more self-healing (Lotryl 24MA07 and Evatane 3345 PV), others, in contrast, exhibit a low shrinkage and a good self healing (Platamid HX2656, Apolhya®, Pebax 2533). For Apolhya®, it is seen that 20% is preferable to 15% and it is the best mixture (in terms of self-healing/shrinkage compromise).

### Example 5

### Preparation of a Composition Comprising a Supramolecular Polymer B Obtained in Example 2, Silica and a Condensation Polymer which is a Grafted Copolymer Comprising Polyamide Blocks (Apolhya®) in the Powder Form

1000 g of Pripol 1040 (Croda, 3.32 mol of COOH functional group), 124 g of Ultrasil VN3 silica (Evonik) and 309 g of powdered Apolhya® (Arkema) are charged to a jacketed 3 liter Schott reactor equipped with a mechanical stirrer of anchor type, a Dean & Stark apparatus surmounted by a reflux condenser, a dropping funnel and a temperature probe. Heating is carried out to 80° C. and 225 g of 95% UDETA (Arkema, 1.66 mol) are added via the dropping funnel, then heating is carried out to 170° C. and reaction is allowed to take place for 3 hours. 36 g of water are recovered in the Dean & Stark apparatus. The temperature of the reaction medium is allowed to return to 120° C. and then 319 g of Epikote 828EL (Resolution, 1.66 mol of epoxide functional group) are added. Stirring is allowed to take place for 15 minutes and then the reactor is emptied via a 2 mm sieve. 1851 g of product are obtained, which product is subsequently heat-treated in an oven in Teflon plates at 120° C. for 24 hours to give the injectable composition.

The product resulting from the heat-treatment can be cut into the form of strips or cryogenically ground in order to obtain a powder or cryogenically fractured in order to obtain granules. The product can be fed to an injection molding machine in these different forms, strips, granules or powder. In this example, the product resulting from the heat treatment was cryogenically fractured. To do this, the product resulting from the heat treatment, in the form of 27×37 cm plates with a thickness of 2-5 mm, was cooled in a freezer at −15° C. The cold product was broken into pieces using a mallet and fed, at the same time as an at least equivalent weight of dry ice, to a mill of Gericke brand comprising a 5 mm pass mesh. 1% of Ultrasil VN3 silica (Evonik) was subsequently added to the ground products in order to prevent reagglomeration and the dry ice was allowed to evaporate on storage in a room at 21° C.

The granules thus obtained were fed to an injection molding machine sold by Arburg under the Allrounder name exhibiting a clamping force of 35 tons. The diameter of the plasticizing screw is 30 mm for a Length/Diameter ratio of 15. The injection temperature used is 155° C. and the mold is regulated at 25° C. The part, injected in less than one second (0.8 s), is a dumbbell of IFC type. The holding time is 18 s at a holding pressure of 50 bar hydraulic. The cooling time in the mold is 30 s. Under these conditions, the final shrinkage of the part is approximately 8%.

### Example 6

### Preparation of a Composition Comprising a Supramolecular Polymer B Obtained in Example 2, Silica and a Condensation Polymer which is a Crafted Copolymer Comprising Polyamide Blocks (Apolhya®) in the Form of Microgranules

670 g of Pripol 1040 (Croda, 2.22 mol of COOH functional group), 83 g of Ultrasil VN3 silica (Evonik) and 207 g of Apolhya® (Arkema) as microgranules are charged to a jacketed 3 liter Schott reactor equipped with a mechanical stirrer of anchor type, a Dean & Stark apparatus surmounted by a reflux condenser, a dropping funnel and a temperature probe. Heating is carried out to 80° C. and 151 g of 95% UDETA (Arkema, 1.11 mol) are added via the dropping funnel, then heating is carried out to 170° C. and reaction is allowed to take place for 3.5 hours. 22 g of water are recovered in the Dean & Stark apparatus. The temperature of the reaction medium is allowed to return to 120° C. and then 214 g of Epikote 828EL (Resolution, 1.11 mol of epoxide functional group) are added. Stirring is allowed to take place for 15 minutes and then the reactor is emptied. 1281 g of product are obtained, which product is subsequently heat-treated in an oven in Teflon plates at 120° C. for 24 hours to give the injectable composition.

The product resulting from the heat treatment was cryogenically fractured as indicated in example 5.

The granules thus obtained were fed to an injection molding machine sold by Arburg under the Allrounder name exhibiting a clamping force of 35 tons. The diameter of the plasticizing screw is 30 mm for a Length/Diameter ratio of 15. The injection temperature used is 155° C. and the mold is regulated at 20° C. The part, injected in less than one second (0.8 s), is a dumbbell of IFC type. The holding time is 10 s at a holding pressure of 35 bar hydraulic. The cooling time in the mold is 30 s. Under these conditions, the final shrinkage of the part is approximately 17%.

### Example 7

### Preparation of a Composition Comprising a Supramolecular Polymer B Obtained in Example 2, Silica and a Condensation Polymer which is a PEBA

665 g of Pripol 1040 (Croda, 2.20 mol of COOH functional group), 82 g of Ultrasil VN3 silica (Evonik) and 205 g of Pebax 2533 (Arkema) as granules are charged to a jacketed 3 liter Schott reactor equipped with a mechanical stirrer of anchor type, a Dean & Stark apparatus surmounted by a reflux condenser, a dropping funnel and a temperature probe. Heating is carried out to 80° C. and 150 g of 95% UDETA (Arkema, 1.10 mol) are added via the dropping funnel, then heating is carried out to 170° C. and reaction is allowed to take place for 3 hours. 26 g of water are recovered in the Dean & Stark apparatus. The temperature of the reaction medium is allowed to return to 120° C. and then 212 g of Epikote 828EL (Resolution, 1.10 mol of epoxide functional group) are added. Stirring is allowed to take place for 15 minutes and then the reactor is emptied. 1257 g of product are obtained, which product is subsequently heat-treated in an oven in Teflon plates at 120° C. for 24 hours to give the injectable composition.

The product resulting from the heat treatment was cryogenically fractured as indicated in example 5.

The granules thus obtained were fed to an injection molding machine sold by Arburg under the Allrounder name exhibiting a clamping force of 35 tons. The diameter of the plasticizing screw is 30 mm for a Length/Diameter ratio of 15. The injection temperature used is 175° C. and the mold is regulated at 30° C. The part, injected in less than one second (0.8 s), is a dumbbell of IFC type. The holding time is 40 s at a holding pressure of 25 bar hydraulic. The cooling time in the mold is 30 s. Under these conditions, the final shrinkage of the part is approximately 7%.

### Example 8

### Grinding and Mixing of Supramolecular Polymer B Obtained in Example 2, Silica and a Condensation Polymer which is a PEBA

300 g of supramolecular polymer obtained according to example 2 were cryogenically fractured as described in example 5. The ground product was sieved in order to isolate the 3-5 mm fraction, and 6% of Ultrasil VN3 silica (Evonik) was added. The granules thus obtained were mixed with Apolhya® (Arkema) granules as a dry 80% supramolecular polymer/20% Apolhya® mixture. This mixture was fed to an injection molding machine sold by Arburg under the Allrounder name exhibiting a clamping force of 35 tons. The diameter of the plasticizing screw is 30 mm for a Length/Diameter ratio of 15. The injection temperature used is 160° C. and the mold is regulated at 30° C. The part, injected in less than one second (0.8 s), is a dumbbell of IFC type. The holding time is 30 s at a holding pressure of 125 bar hydraulic. The cooling time in the mold is 30 s. Under these conditions, the final shrinkage of the part is approximately 11%.

1-14. (canceled)

15. A composition comprising:
(i) from 0.1 to 49 parts by weight of at least one thermoplastic condensation polymer; and
(ii) from 51 to 99.9 parts by weight of at least one supramolecular polymer capable of being obtained by the reaction of at least one at least trifunctional compound (A) carrying first and second functional groups with:
at least one compound (B) carrying at least one reactive group capable of reacting with the first functional groups of (A) and at least one associative group; and
at least one at least bifunctional compound (C), the functional groups of which are capable of reacting with the second functional groups of the compound (A) in order to form ester, thioester or amide bridges.

16. The composition of claim 15, wherein the condensation polymer is a polymer comprising a polyamide, polyester, polyether, polyetherester, polyurethane or polyurea block.

17. The composition of claim 15, wherein the condensation polymer is chosen from homopolyamides and copolyamides.

18. The composition of claim 15, wherein the compound (A) is a trimer of at least one of the following acids: undecylenic acid, myristoleic acid, palmitoleic acid, oleic acid, linoleic acid, linolenic acid, ricinoleic acid, eicosenoic acid, docosenoic acid, eicosapentaenoic acid and docosahexaenoic acid.

19. The composition of claim 15, wherein the compound (A) is a mixture of fatty acid trimer and of dicarboxylic acid chosen from: a linear alkanedicarboxylic acid and a branched alkanedicarboxylic acid.

20. The composition of claim 19, wherein the linear alkanedicarboxylic acid is chosen from glutaric acid, adipic acid, pimelic acid, suberic acid, azelaic acid, sebacic acid, undecanedioic acid, dodecanedioic acid, brassylic acid, tetradecanedioic acid, pentadecanedioic acid, thapsic acid, and octadecanedioic acid.

21. The composition of claim 19, wherein the branched alkanedicarboxylic acid is 3,3-dimethylglutaric acid.

22. The composition of claim 15, wherein the compound (B) corresponds to one of the formulae (B1) to (B5): 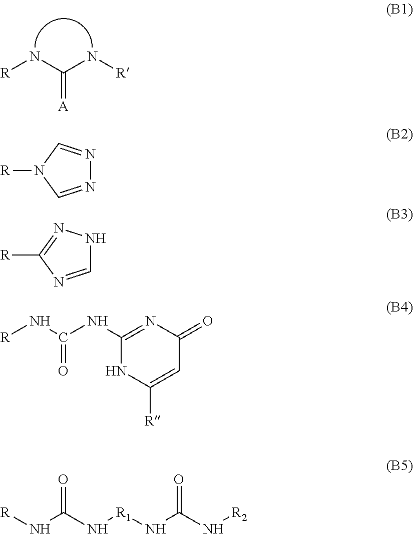
wherein:
R denotes a unit comprising at least one reactive functional group,
R′ denotes a hydrogen atom,
R″, R₁ and R₂ denote any group,
A denotes an oxygen or sulfur atom or an —NH group.

23. The composition of claim 22, wherein the compound (B) is chosen from: 2-aminoethylimidazolidone, 1-(2-[(2-aminoethyl)amino]ethyl)imidazolidone, 1-(2-[2-{2-aminoethylamino}ethylamino]ethyl)imidazolidone, N-(6-aminohexyl)-N′-(6-methyl-4-oxo-1,4-dihydropyrimidin-2-yl)urea, 3-amino-1,2,4-triazole and 4-amino-1,2,4-triazole.

24. The composition of claim 15, wherein the compound (B) corresponds to formula (B1): 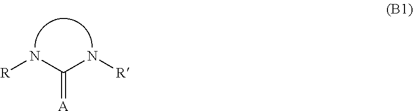
wherein:
R denotes a unit comprising at least one reactive functional group,
R′ denotes a hydrogen atom, and
A denotes an oxygen atom.

25. The composition of claim 15, wherein the compound (C) carries at least two identical or different functional groups chosen from epoxy, alcohol and amine functional groups.

26. The composition of claim 15, wherein the compound (C) corresponds to the formula (I):
H₂N—(CHR₁)ₘ—(CHR₂)ₙ—[NH—(CH₂)ₓ]_{y}—NH—(CHR₃)ₚ—(CHR₄)_{q}—NH₂ (I)
wherein:
R₁, R₂, R₃ and R₄ independently denote a hydrogen atom or a C₁-C₆ alkyl group,
m, n, p and q independently denote an integer ranging from 1 to 3,
x denotes an integer ranging from 1 to 6, and
y denotes an integer ranging from 0 to 2.

27. The composition as claimed in claim 26, wherein, in the formula (I), at least one and preferably all of the following conditions are satisfied:
R₁, R₂, R₃ and R₄ denote a hydrogen atom,
m+n is equal to 2, 3 or 6,
p+q is equal to 2, 3 or 6,
x denotes an integer ranging from 2 to 4,
y is equal to 0 or 1.

28. The composition as claimed in claim 26, wherein, in the formula (I):
R₁, R₂, R₃ and R₄ denote a hydrogen atom,
m+n is equal to 2, 3 or 6,
p+q is equal to 2, 3 or 6,
x denotes an integer ranging from 2 to 4, and
y is equal to 0 or 1.

29. The composition of claim 15, wherein the compound (C) is chosen from: diethylenetriamine, triethylenetetramine, tetraethylenepentamine, di hexylenetriamine, cadaverine, putrescine, hexamethylenediamine, 1,12-diaminododecane or a cyclic alkylenediamine.

30. The composition of claim 29, wherein the compound (C) is isophoronediamine.

31. The composition of claim 15, wherein the supramolecular polymer is reacted with urea.

32. The composition of claim 15, further comprising an inorganic filler.

33. A process for the manufacture of the composition of claim 15, said process comprising:
a step of reacting the first functional groups of the at least one compound (A) with the at least one compound (B);
a step of reacting the at least one compound (C) with the second functional groups of the at least one compound (A) to form ester, thioester or amide bridges and to form the at least one supramolecular polymer,
optionally a step of reacting the at least one supramolecular polymer with urea, and
a step of adding the at least one thermoplastic condensation polymer before, during or after any one of the above steps.
